(19) United States
(12) Patent Application Publication
(10) Pub. No.: US 2015/0224685 A1
(43) Pub. Date: Aug. 13, 2015

(54) SYSTEM AND METHOD FOR MANUFACTURING AN ARTICLE

(71) Applicant: Caterpillar Inc., Peoria, IL (US)

(72) Inventor: Aaron K. Amstutz, Peoria, IL (US)

(73) Assignee: Caterpillar Inc., Peoria, IL (US)

(21) Appl. No.: 14/179,621

(22) Filed: Feb. 13, 2014

(51) Int. Cl. B29C 43/18; B32B 15/18; B32B 15/04; B32B 7/12; B32B 13/06

(52) U.S. Cl. CPC B29C 43/18; B32B 7/12; B32B 13/06; B32B 15/04; B32B 15/18; B29C 2043/181; B32B 2250/03; B32B 2250/40

(57) ABSTRACT

The present disclosure is related to a system for manufacturing an article. The system includes a first mold half and a second mold half. The first mold half and the second mold half define a molding cavity therebetween. The molding cavity is configured to receive two outer layers and a high viscosity material provided between the two outer layers. The system also includes an actuator configured to move at least one of the first mold half and the second mold half towards the other. The first mold half and the second mold half are configured to deform the high viscosity material in conformation with a shape of the article. The high viscosity material fills a space between the two outer layers such that the two outer layers encase the high viscosity material therebetween.

### TECHNICAL FIELD

The present disclosure relates to a system and method for manufacturing an article, and more specifically to a system and method for manufacturing an article comprising a high viscosity composite.

### BACKGROUND

High viscosity materials, such as thermoset plastics, thermoset elastomers, pre-heated thermoplastics, cementitious composites, and the like exhibit properties which may provide benefits and advantages as a compositional substance for a variety of articles. For example, cementitious composites in the class of macro-defect-free (MDF) cements can be characterized by high stiffness as compared to other cementitious materials and as a result may be desirable for use in various applications. However, other material properties, such as, for example, the high degree of adhesiveness of high viscosity materials may present difficulties and may render such materials impracticable for numerous fabrication processes. Additional properties and characteristics may present challenges and limitations in terms of the utilization of these materials for certain applications. For example, the hydrophilic properties of MDF cements can cause these cements to be susceptible to the tendency to absorb moisture, which, in turn, can reduce the strength and stiffness of the material. Furthermore, MDF cements may be brittle and susceptible to surface defects, such as cracks, which may resultantly cause premature failure of products made of MDF cements. These and other challenges and limitations may serve as impediments to the use of high viscosity materials, such as thermoset plastics, thermoset elastomers, pre-heated thermoplastics, and cementitious composites, and the beneficial characteristics thereof. Consequently, present methods have been substantially limited to casting low-viscosity cement products into plastic or steel forms to create articles with less risk of surface cracking or abrasion.

U.S. Pat. No. 6,722,009 B2 (the '009 patent) to Kojima et al. discloses a sheet hydroforming method. According to the hydroforming method disclosed by the '009 patent, two stacked metallic sheets are clamped between a pair of upper and lower dies. A fluid is introduced and pressurized between mating surfaces of the metallic sheets, causing the metallic sheets to bulge into a space defined by die cavities. A thru-hole for introducing the fluid is formed in one of the dies so as to lead to a holding surface of the die, and a pierced hole for introducing the fluid is formed in one of the metallic sheets in a portion of the one metallic sheet which portion is in contact with a holding surface of one of the dies. The pierced hole is positioned with the thru-hole, and then the fluid is introduced in a pressurized state between mating surfaces of the metallic sheets from the thru-hole through the pierced hole, thereby causing the metallic sheets to bulge.

The present disclosure is directed to mitigating or eliminating one or more of the drawbacks discussed above.

### SUMMARY OF THE DISCLOSURE

In one aspect of the present disclosure, a system for manufacturing an article is disclosed. The system includes a first mold half and a second mold half. The first mold half and the second mold half define a molding cavity therebetween. The molding cavity is configured to receive two outer layers and a high viscosity material provided between the two outer layers. The system also includes an actuator configured to move at least one of the first mold half and the second mold half towards the other. The first mold half and the second mold half are configured to deform the high viscosity material in conformation with a shape of the article. The high viscosity material fills a space between the two outer layers such that the two outer layers encase the high viscosity material therebetween.

In another aspect, a method of manufacturing an article is disclosed. The method includes providing a molding cavity between a first mold half and a second mold half. The method also includes receiving two outer layers containing a high viscosity material therebetween in the molding cavity. The method further includes moving at least one of the first mold half and the second mold half towards the other. The method includes deforming the high viscosity material by the first mold half and the second mold half in conformation with a shape of the article. The high viscosity material deforms the two outer layers such that the two outer layers encase the high viscosity material therebetween.

In yet another aspect, an article is disclosed. The article includes a cementitious composite formed in a shape of the article. The article also includes two metal sheets encasing the cementitious composite therebetween.

### BRIEF DESCRIPTION OF THE DRAWINGS

FIG. 1 is a front sectional view of an exemplary system for manufacturing an article, according to an embodiment of the present disclosure;

FIG. 2 is a front sectional view of the system of FIG. 1 in a first process step, according to an embodiment of the present disclosure;

FIG. 3 is a front sectional view of the system of FIG. 1 in a second process step, according to an embodiment of the present disclosure;

FIG. 4 is a front sectional view of the system of FIG. 1 in a third process step, according to an embodiment of the present disclosure;

FIG. 5 is a front sectional view of the system of FIG. 1 in a fourth process step, according to an embodiment of the present disclosure;

FIG. 6 is a perspective sectional view of the article, according to another embodiment of the present disclosure; and

FIG. 7 illustrates a flowchart depicting a method of manufacturing an article, according to an embodiment of the present disclosure.

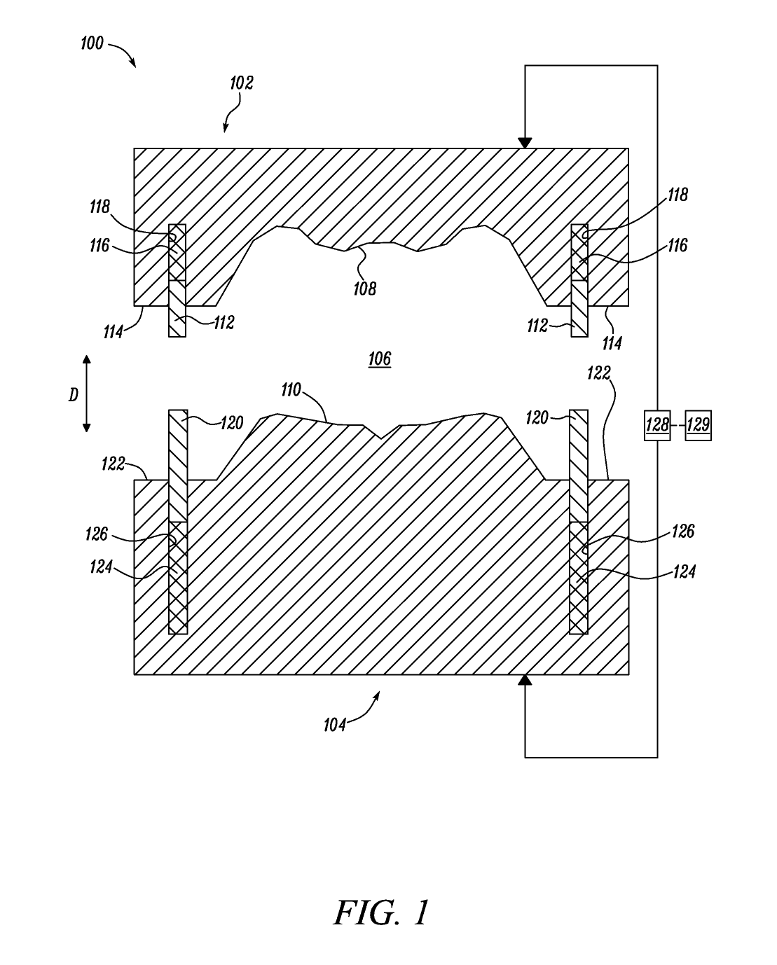

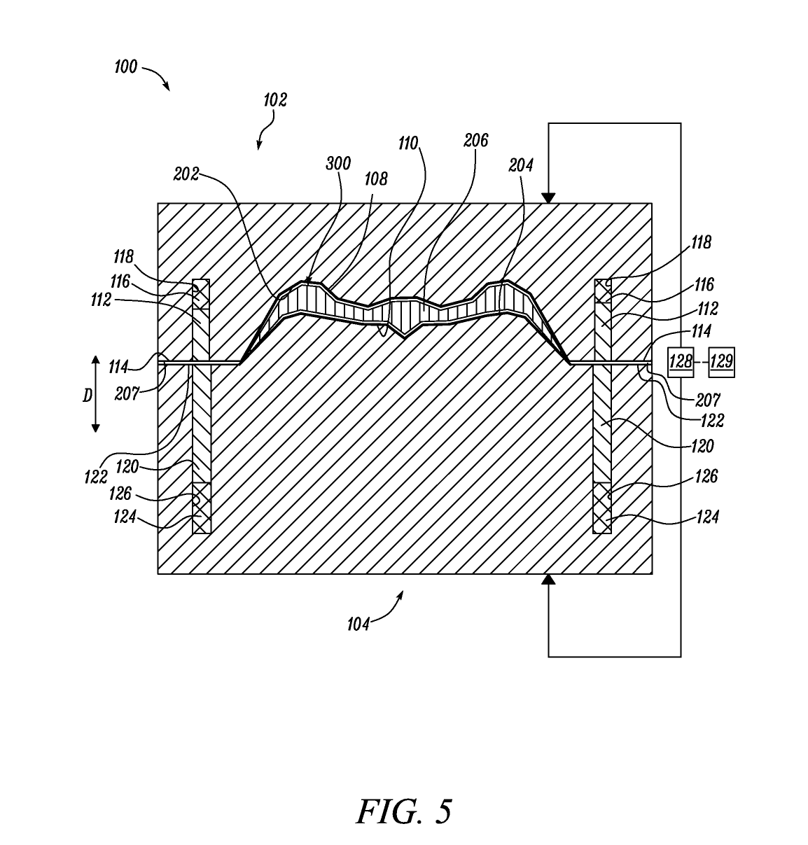

### DETAILED DESCRIPTION

Wherever possible, the same reference numbers will be used throughout the drawings to refer to the same or the like parts. Referring to FIG. 1, an exemplary system 100 is provided for manufacturing an article 300 (shown in FIG. 5). The system 100 includes a first mold half 102 and a second mold half 104. The first mold half 102 and the second mold half 104, 104 include first and second molding surfaces 108 and 110, respectively. The first and second molding surfaces 108, 110 can be shaped and contoured to define a negative or hollow molding cavity 106 to correspondingly define the thickness, shape, and surface contours of the article 300 that is formed between the first and second mold halves 102, 104. Therefore, the first and second molding surfaces 108, 110 may vary depending on the shape of the article 300. One or more of first mold half 102 and the second mold half 104 can be aligned and additionally can be movable along a direction D such that the first and second mold halves 102, 104 can be movably retracted and advanced between a fully open position and a fully closed position wherein the first and second mold halves 102, 104 can be engaged in substantially mating contact to define the hollow molding cavity 106 therebetween. In an embodiment, the first mold half 102 may be movable along a direction D, while the second mold half 104 is stationary. Alternatively, the first mold half 102 may be stationary and the second mold half 104 is movable. Both the first and second mold halves 102, 104 may also be movable.

The first mold half 102 includes one or more spring biased members 112 positioned at, along, or within ends 114 of the first mold half 102. The ends 114 can be straight surfaces on outer sides of the first molding surface 108. Each of the spring biased members 112 can be biased by a spring 116 towards the hollow molding cavity 106. Further, the spring biased members 112 and the springs 116 can be at least partly received within a recesses 118 of the first mold half 102. The spring biased members 112 extend from the recesses 118 into the hollow molding cavity 106. Similarly, the second mold half 104 includes one or more spring biased members 120 positioned at, along, or within ends 122 of the second mold half 104. The two ends 122 can be straight surfaces on outer sides of the second molding surface 110. Each of the spring biased members 120 can be biased by a spring 124 towards the hollow molding cavity 106. Further, the spring biased members 120 and the springs 124 are received within recesses 126 of the second mold half 104. The spring biased members 120 extend from the recesses 126 into the hollow molding cavity 106. The spring biased members 112, 120 can be movable between fully extended positions (illustrated in FIG. 1) to fully retracted positions (illustrated in FIG. 5). In various embodiments, each of the spring biased members 112 and 120 can be embodied as a pin, a ring, or any other similar, suitable structure or member. Further, the springs 116, 124 can be coil springs, rubber members, fluid springs, or any resilient member known in the art. In a particular embodiment, the first mold half 102 can include at least four of the spring biased members 112. Similarly, the second mold half 104 can include at least four of the spring biased members 120. In various other embodiments, the first mold half 102 may include eight or more of the spring biased members 112. Similarly, the second mold half 104 may include eight or more of the spring biased members 120.

The system 100 further includes an actuator 128. The actuator 128 can be configured to actuate the relative movement and position of first mold half 102 and the second mold half 104 to retract and advance along the direction D depending on various stages of manufacturing of the article 300. For example, the first mold half 102 may move towards the second mold half 104, along the direction D, during molding. Further, the first mold half 102 may move away from the second mold half 104 during de-molding. De-molding may include one or more processes and/or devices which are used for removing the article 300 from the hollow molding cavity 106 after molding. The actuator 128 can include a drive (not shown) configured to move the first and second mold halves 102, 104. The drive can be embodied as any suitable drive mechanism, including but not limited to, a mechanical drive, a hydraulic drive, an electric drive, a pneumatic drive, or a combination thereof. The actuator 128 can further include a control module 129. The control module can be communicably coupled to the drive, one or more sensors (e.g., weight sensors, thickness sensors, pressure sensors, displacement sensors etc.), and the like. The control module 129 can be connected in electronic and controllable communication with the actuator 128 to regulate the movements of the first and second mold halves 102, 104 based on the one or more parameters, stored lookup tables, algorithms, and the like. The parameters can include any one or more of molding or de-molding movement values of the first and second mold halves 102, 104, molding pressure or force, weight of molding material, dimensions of the article 300, and the like. The control module 129 can also be configured to receive inputs from an operator via a user interface (not shown). The control module 129 can also have any other functions within the scope of the present disclosure.

The system 100, as described above, is exemplary in nature, and variations are possible within the scope of the present disclosure. For example, depending upon the variables, parameters, or requirements of a particular application, the spring biased members 112, 120 may be removed or eliminated. In an additional or alternative example, one or more separate holders may be provided adjacent to the first and/or second mold halves 102, 104.

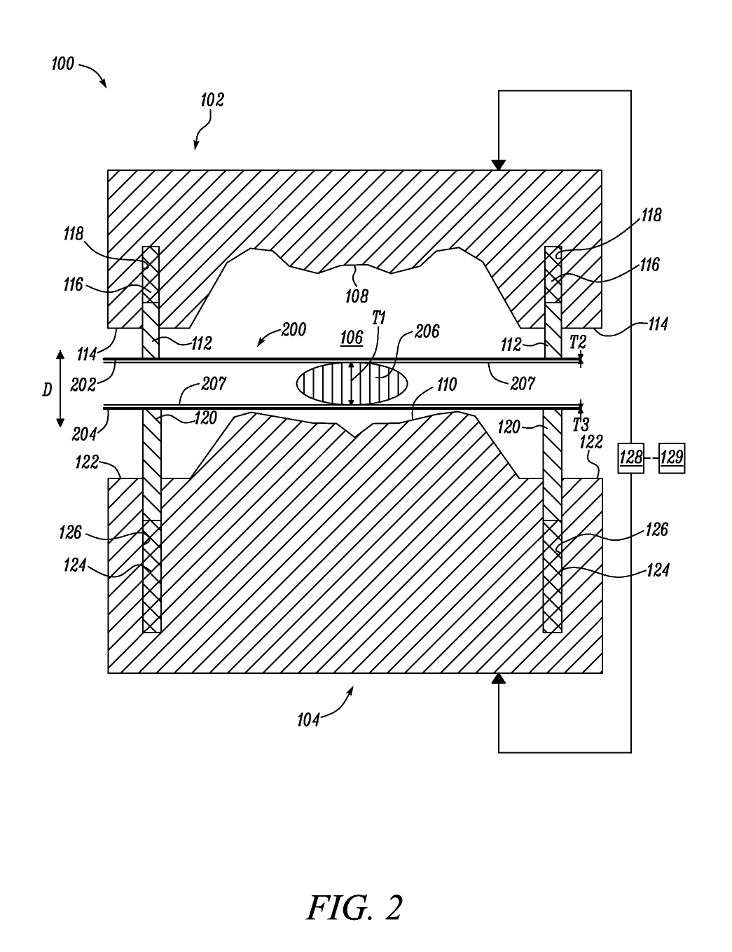

FIGS. 2 to 5 illustrate various process steps of manufacturing the article 300. The process steps can be part of a molding process implemented by the system 100. FIG. 2 illustrates the system 100 receiving the molding material 200 which form and define the composition of the article 300 upon completion of the process steps as disclosed herein. In particular, FIG. 2 illustrates the system 100 receiving the molding material 200 in the hollow molding cavity 106 provided between the first and second mold halves 102, 104. The molding material 200 can be automatically or manually placed in the hollow molding cavity 106. The molding material 200 includes a first outer layer 202, a second outer layer 204, and a high viscosity material 206 provided between the first and second outer layers 202, 204.

In an embodiment, the first and second outer layers 202, 204 can be in the form of metal sheets. The metal sheets can be plates or foils depending on the thicknesses T2 and T3 of the first and second outer layers 202, 204, respectively. For example, the first and second outer layers 202, 204 can be metal foils if the thickness T2 and T3 are less than 1 mm. Further, the first and second outer layers 202, 204 can be made of any metal or metal alloy, for example, but not limited to, various grades of steel, aluminum, magnesium, copper, or alloys thereof. The first and second outer layers 202, 204 can have similar or different dimensions. In a particular embodiment, the first and second outer layers 202, 204 can be ferrous materials with thickness between 0.1 and 1.0 mm. In another embodiment, the first and second outer layers 202, 204 can be stainless steel with thickness between 0.1 and 0.5 mm.

In an embodiment, the high viscosity material 206 can be a thermoset plastic, a thermoset elastomer, a pre-heated thermoplastic, a cementitious composite, and the like. The high viscosity material 206 can have a viscosity equal to or above 10,000,000 centipoise; this can be measured using a Mooney Viscometer and would have a viscosity above 50 Mooney Units. In another embodiment, the high viscosity material 206 can be a macro-defect-free (MDF) cement. The MDF cement can include any MDF cement known in the art. For example, the MDF cement can include a cement material, water and one or more polymers. Further, MDF cements can be made in one or more processes known in the art. For example, the cement material, water and the polymers can be pre-mixed, and then subjected to shear mixing and/or calendaring in roll mills. Further, the MDF cement can be formulated to bond to metallic foils during curing without the use of an additional adhesive. A person ordinarily skilled in the art may appreciate that MDF cements can have a high viscosity in uncured state, for example, equal to or above 10,000,000 centipoise or 50 Mooney Units as measured on a Mooney Viscometer.

In an embodiment, an adhesive 207 may be utilized to bond the high viscosity material 206 with the first and second outer layers 202, 204, wherein the adhesive 207 may be applied to an inner surface of each of the first and second outer layers 202, 204 facing the high viscosity material 206, and in one example may be pre-coated on the inner surface of each of the first and second outer layers 202, 204. Alternatively, the adhesive 207 may be applied to the high viscosity material 206. The adhesive 207 may be a heat activated adhesive. In an embodiment, the adhesive 207 may be Chemlok® 213 from Lord Corporation.

The molding material 200, as illustrated in FIG. 2, is exemplary in nature, and variations are possible within the scope of the present disclosure. For example, a maximum thickness T1 of the high viscosity material 206 can be changed according to requirements of the article 300 and/or the specifications of the system 100. Further, other dimensions and a shape of the high viscosity material 206 may vary accordingly. Similarly, thicknesses T2 and T3 of the first and second outer layers 202, 204, respectively, can additionally be changed according to requirements of the article 300 and/or the specifications of the system 100, and additionally, or alternatively, the first and second outer layers 202, 204 can have variable thickness at various areas or portions thereof. The first and second outer layers 202, 204 can also be any one of a plurality of suitable shapes, such as, for example, circular, polygonal, elliptical, and the like.

Further, the springs 116, 124 can bias the spring biased members 112, 120 to contact the first and second outer layers 202, 204, respectively. The spring biased members 112, 120 can retain the first and second outer layers 202, 204 at the ends 114, 122 of the first and second mold halves 102, 104, respectively. The spring biased members 112, 120 can therefore prevent any movement of the first and second outer layers 202, 204 relative to the first and second mold halves 102, 104, along a direction perpendicular to the direction D.

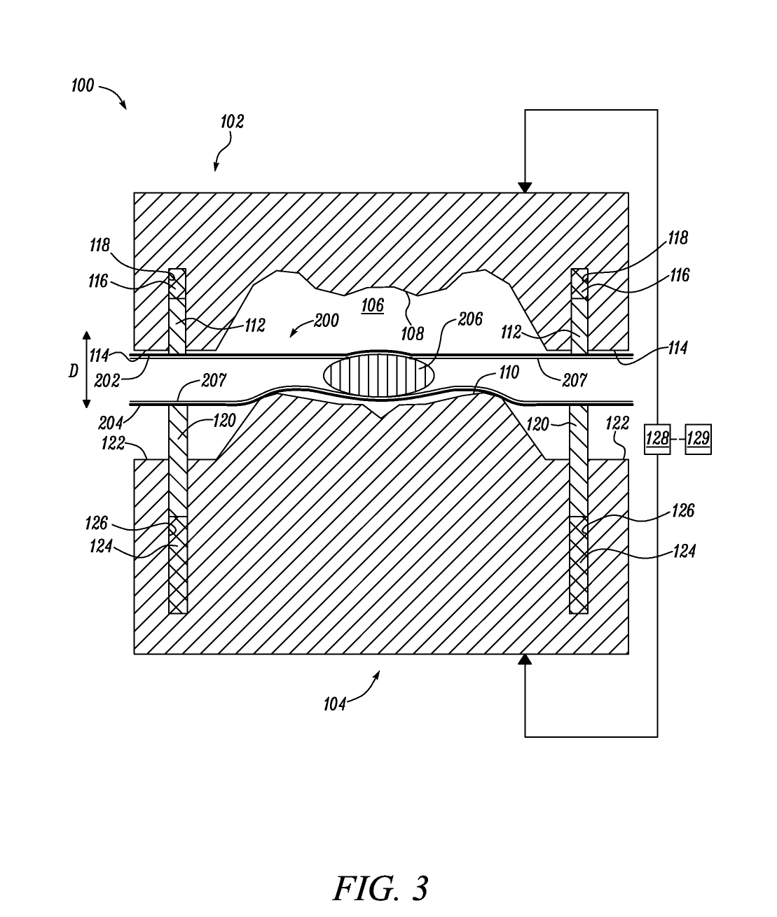

FIG. 3 illustrates the actuator 128 moving the first mold half 102 towards the second mold half 104. The first outer layer 202 can push the spring biased members 112 at least partly within the recesses 118 against the biasing of the springs 116. The spring biased members 112 can be in the fully retracted position within the recesses 118. Consequently, the spring biased members 112 can just begin to displace the first outer layer 202 over the high viscosity material 206. The shape of the high viscosity material 206 can remain substantially similar to a shape shown in FIG. 2. The first outer layer 202 can deform over the high viscosity material 206. Further, the high viscosity material 206 can also apply force on the second outer layer 204 and initiate a deformation of the second outer layer 204 against the second molding surface 110 of the second mold half 104. Moreover, the spring biased members 120 can remain in an extended position substantially similar to the extended position in FIG. 2.

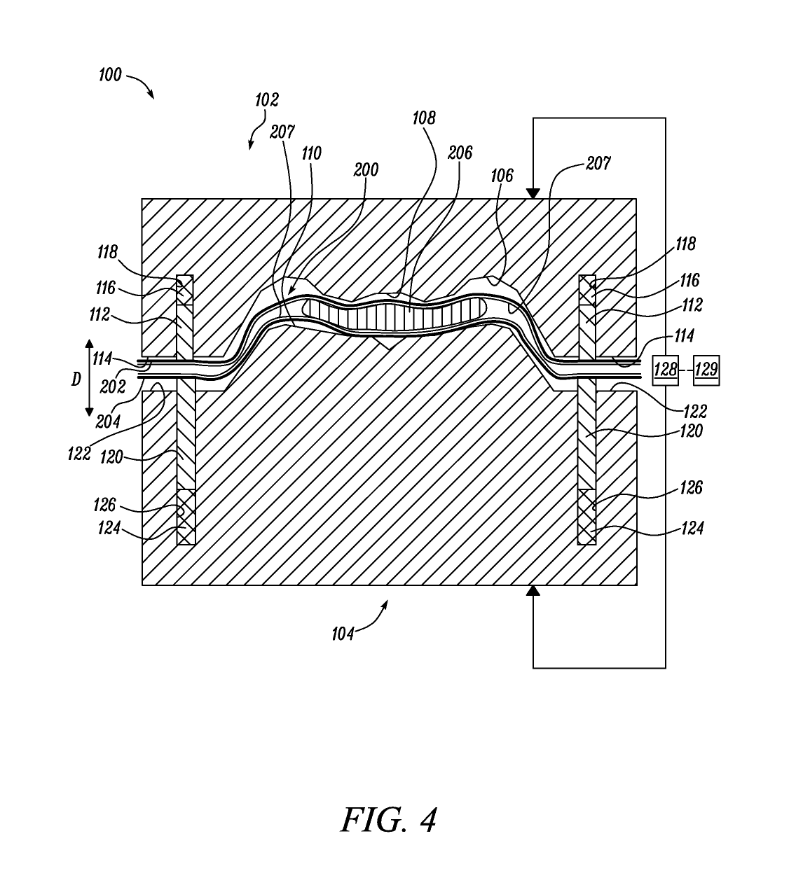

FIG. 4 illustrates the first mold half 102 moved closer to the second mold half 104, as compared to the position in FIG. 3. Consequently, the spring biased members 120 can be in a partially retracted position within the recesses 126 of the second mold half 104. The high viscosity material 206 can deform further and apply force against the first and second outer layers 202, 204. The first and second outer layers 202, 204 can therefore deform against the first and second molding surfaces 108, 110, respectively. The spring biased members 112, 120 can continue to retain the first and second outer layers 202, 204. Further, the spring biased members 112, 120 can move the first and second outer layers 202, 204 closer to each other along the direction D.

FIG. 5 illustrates a final position of the first and second mold halves 102, 104 during the molding process. The ends 114, 122 of the first and second mold halves 102, 104, respectively, can be substantially in contact with each other in the final position. In an alternate embodiment, a minimum clearance (not shown) may be present between the ends 114, 122 of the first and second mold halves 102, 104, respectively, in the final position. Both the spring biased members 112, 120 can be in the fully retracted positions. The article 300 has been formed in FIG. 5. The high viscosity material 206 can deform in conformation with the shapes of the first and second molding surfaces 108, 110. The first and second mold halves 102, 104 can therefore compress the high viscosity material 206 therebetween within the hollow molding cavity 106 in engagement with the first and second molding surfaces 108, 110 causing the high viscosity material 206 to deform in conformation therewith to form the thickness, shape and surface contours of the article 300. The shape and thickness of the article 300 can be defined by the hollow molding cavity 106 between the first and second molding surfaces 108, 110. The first and second outer layers 202, 204 can also conform to the shapes of the first and second molding surfaces 108, 110, respectively. Further, the high viscosity material 206 can fill a space between the first and second outer layers 202, 204. It is contemplated that an amount of the high viscosity material 206 can depend at least on the dimensions of the article 300 such that an amount the high viscosity material 206 can be selected to at least fill the space between the first and second outer layers 202, 204 due to deformation. It is anticipated that the compaction pressure can be at least 5 MPa.

The spring biased members 112, 120 can move the first and second outer layers 202, 204 further closer to each other. Further, the first and second outer layers 202, 204, respectively, can contact each other at the between the ends 114, 122 of the first and second mold halves 102, 104, respectively. The high viscosity material 206 can also deform the first and second outer layers 202, 204 in conformation with the shapes of the first and second molding surfaces 108, 110, respectively. Therefore, the first and second outer layers 202, 204 can encase the high viscosity material 206 between them. In an embodiment, the adhesive 207, which is pre-coated on the first and second outer layers 202, 204, can bond the first and second outer layers 202, 204 to each other at the ends 302, 304 of the article 300. Moreover, the first and second outer layers 202, 204 can encase the high viscosity material 206 between them. Further, the article 300 is formed in FIG. 5. The article 300 can be de-molded thereafter. De-molding can involve moving the first mold half 102 away from the second mold half 104. The article 300 can be then manually or automatically ejected from the system 100.

The various process steps, as described above, are exemplary in nature, the process steps may vary according to specifications and/or parameters of the system 100 and the article 300. Deformations of the first and second outer layers 202, 204, and the high viscosity material 206 may also vary in intermediate process steps, as described in FIGS. 3 and 4. In an embodiment, the first and/or second mold halves 102, 104 can be coupled to a heating module (not shown) such that the first and second molding surfaces 108, 110 are heated during the molding process. This can at least partially cure the high viscosity material 206. Further, in case the adhesive 207 is heat activated, the adhesive 207 can bond the first and second outer layers 202, 204 to the high viscosity material 206 during the molding process. Further, a duration and a temperature of the molding process can change based on various parameters, for example, a thickness of the article 300, properties of the high viscosity material 206, a cost associated with the molding process, and so on. In an example, the molding process can include curing the high viscosity material 206 at a temperature of about 90 degrees Celsius for about 30 minutes per 5 mm thickness of the article 300.

Additional processing can also be performed to the article 300 formed in FIG. 5. In an example, the high viscosity material 206 can be partially cured during the molding process to an extent that the article 300 is dimensionally stable. Therefore, in an embodiment, the article 300 can undergo a post-curing process. The post-curing can complete the curing of the high viscosity material 206. In an example, the article 300 can be post-cured at about 90 degrees Celsius for about 16 to 72 hours. Alternatively, the article 300 can be post-cured at higher temperatures for shorter durations, for example, temperatures up to 135 degrees Celsius for about 8 hours. Moreover, the article 300 can undergo one or more finishing processes. For example, the article 300 can undergo one or more of machining, grinding, painting, heat treatment, and the like.

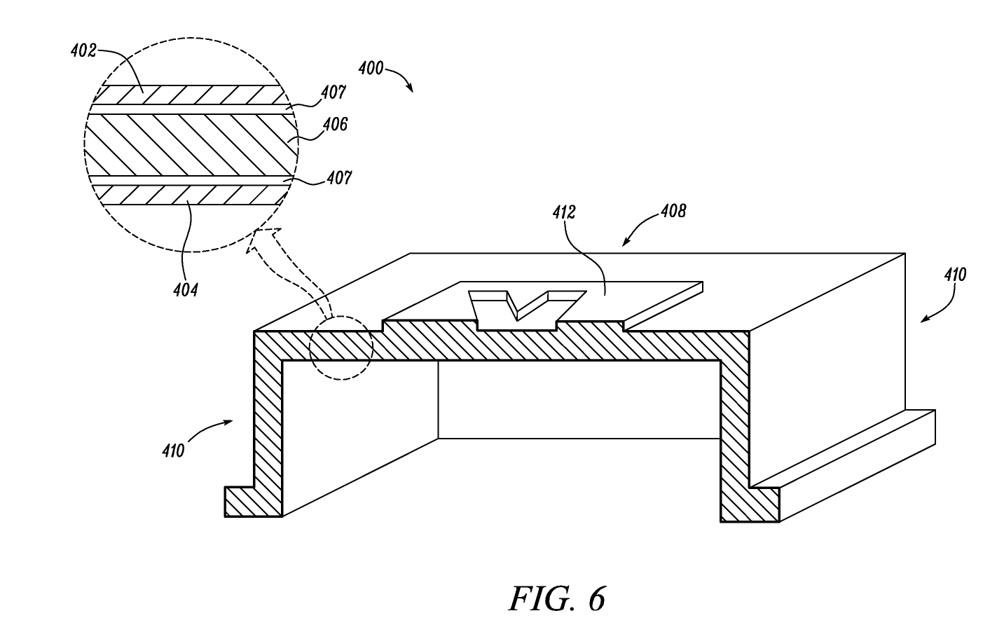

FIG. 6 illustrates an article 400, according to another embodiment of the present disclosure. In particular, FIG. 6 depicts one example of a finished article 400 which can be manufactured by the system 100 in accordance with the process steps described with reference to FIGS. 2 to 5 and thus can have a composition consistent with the article 300 described above. As shown in the detailed view in FIG. 6, the article 400 includes a first outer layer 402, a second outer layer 404, and a high viscosity material 406 encased between the first and second outer layers 402, 404. In an embodiment, the high viscosity material 406 can be a cementitious composite which forms or defines the interior of the article 400. The high viscosity material 406, and the composition thereof, can be correspondingly equivalent to the high viscosity material 206. As such, the high viscosity material 406, in one embodiment, can be an MDF cement, or can include any other material and composition consistent with that of the high viscosity material 206 according to any one of the embodiments as disclosed herein. In a manner which can be further consistent with the article 300, the composition and formation of the first and second outer layers 402, 404 of the article 400 can also be correspondingly equivalent to that of the first and second outer layers 202, 204, respectively, of the article 300, and thus, can be metal sheets such as plates or foils which can encase the high viscosity material 406 therebetween and can have a thickness and/or material composition consistent with any of the embodiments of the first and second outer layers 202, 204 disclosed herein. In another embodiment, an adhesive 407 may form an additional layer at the interface between the high viscosity material 406 which can be a cementitious composite which forms or defines the interior of the article 400 and the first and second outer layers 402, 404 in a manner consistent with the corresponding embodiment of the article 300 above. Further addressing FIG. 6 which illustrates an exemplary embodiment of one possible shape of article 400, the article 400 can include a middle section 408 which can be defined as a base and one or more lateral sections 410 which can form walls extending outward from, and in one embodiment, as extensions of the middle section 408 to form the article 400 as a substantially unitary body. Further, the middle section 408 can include a raised portion 412 which can define a logo or a pattern. In another embodiment, one or more of the lateral sections 410 can alternatively or additionally include a raised portion 412. The exemplary embodiment of FIG. 6 illustrates a substantially planar middle section 408 and substantially planar, flanged lateral sections 410 oriented and positioned to define the article 400 as a substantially box-shaped three-dimensional structure. However, it should be understood that middle section 408 and/or the one or more lateral sections 410 can be formed to include a variety of additional or differing contours, features, and positional arrangements to thus form the article 400 as including any one of a plurality of additional or differing shapes, structures, and features.

### INDUSTRIAL APPLICABILITY

High viscosity materials, such as thermoset plastics, thermoset elastomers, pre-heated thermoplastics, cementitious composites, and the like are known in the art. Molding of such high viscosity materials may be difficult. Further, MDF cements are an example of a type of cementitious composite. MDF cements may tend to absorb moisture and are susceptible to surface defects, such as cracks.

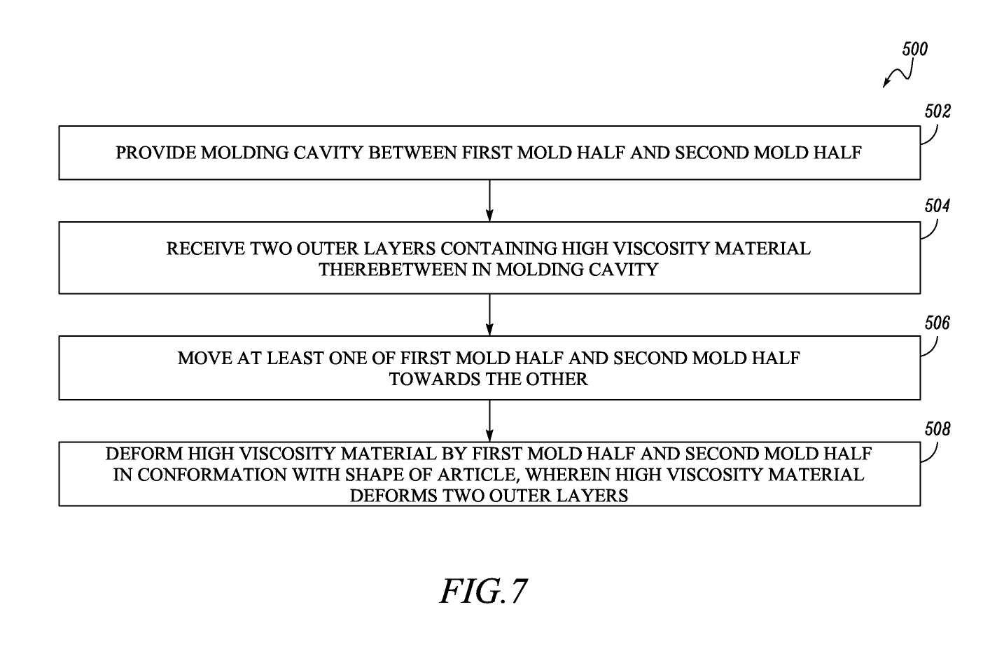

The present disclosure is related to the system 100 for molding high viscosity materials, such as thermoset plastics, thermoset elastomers, pre-heated thermoplastics, cementitious composites, and the like. The present disclosure is also related to a method for manufacturing an article (For example, the articles 300 and 400). FIG. 7 illustrates the method 500 for manufacturing the article 300, according to an embodiment of the present disclosure. Reference will also be made to FIGS. 1 to 5.

At step 502, the method 500 includes providing the hollow molding cavity 106 between the first and second mold halves 102, 104. The system 100 includes the first and second mold halves 102, 104. At step 504, the method 500 includes receiving the first and second outer layers 202, 204 containing the high viscosity material 206 between them in the hollow molding cavity 106. Any manual or automatic processes and/or devices may place the first and second outer layers 202, 204 and the high viscosity material 206 in the hollow molding cavity 106. Further, the spring biased members 112, 120 may retain the first and second outer layers 202, 204 between them in the hollow molding cavity 106. The first and second outer layers 202, 204 may be pre-coated with the adhesive 207. At step 506, the method 500 includes moving at least one of the first and second mold halves 102, 104 towards the other. The actuator 128 may move the first mold half 102 towards the second mold half 104.

At step 508, the method 500 includes deforming the high viscosity material 206 by the first and second mold halves 102, 104 in conformation with the shape of the article 300. The shape of the article 300 is defined by the first and second molding surfaces 108, 110 of the first and second mold halves 102, 104, respectively. In an embodiment, the heating module associated with the first and/or second mold halves 102, 104 may heat the first and second molding surfaces 108, 110 during the molding process. This may at least partially cure the high viscosity material 206. Further, in case the adhesive 207 is heat activated, the adhesive 207 may bond the first and second outer layers 202, 204 to the high viscosity material 206 during the molding process.

The first and second outer layers 202, 204 may prevent the high viscosity material 206 from sticking to the first and second molding surfaces 108, 110. The high viscosity material 206 may deform the first and second outer layers 202, 204 against the first and second molding surfaces 108, 110, respectively, during molding. Therefore, a separate pressure source (for example, a high pressure fluid) may not be required to form the first and second outer layers 202, 204. Further, deformation by the high viscosity material 206 may provide accurate forming of the first and second outer layers 202, 204 in conformation with the first and second molding surfaces 108, 110, respectively. The system 100 and the method 500 may thus enable cost efficient and accurate manufacture of the article 300.

Further, the first and second outer layers 202, 204 encase the high viscosity material 206 between them. The first and second outer layers 202, 204 may therefore prevent the high viscosity material 206, such as an MDF cement, from absorbing moisture. Further, the first and second outer layers 202, 204 may substantially prevent formation of any surface defects, such as cracks on the MDF cement. Moreover, the first and second outer layers 202, 204 may also increase a stiffness of the article 300. The article 300 may therefore have improved stiffness and long life.

After step 508, the actuator 128 may move the first mold half 102 away from the second mold half 104. Further, any de-molding processes and/or devices may remove the article 300 from the hollow molding cavity 106. In an embodiment, the article 300 may then undergo a post-curing process. The post-curing may complete the curing of the high viscosity material 206.

Though the method 500 was described above with respect to the article 300, the method 500 may be used for manufacturing any article having two outer layers encasing a high viscosity material between them. For example, the method 500 may be used to manufacture the article 400 (shown in FIG. 6). The articles 300 and 400 are exemplary and may include, for example, but not limited to, valve covers, oil pans, front covers of engines, floors and walls of machine cabs, brackets, enclosures or hoods and so on. MDF cements may also have a lower cost as compared to other materials, such as thermoset polymers and aluminum. Therefore, in cases where the high viscosity materials 206, 406 are MDF cements, the articles 300 and 400 may have lower cost as compared to articles made of aluminum or thermoset polymers. Moreover, MDF cements have a higher stiffness compared to traditional thermoset polymer composites. Consequently, the articles 300 and 400 also have a high stiffness.

The present disclosure may provide a system and method for manufacturing which effectively incorporates macro-defect free cements as well as other high viscosity materials in the formation of articles which exhibit the beneficial properties of these materials while overcoming the difficulties which may have traditionally limited their use. As provided herein, while MDF cements and other high viscosity materials exhibit high stiffness as compared to conventional cementitious materials and lower cost, traditional manufacturing methods may be ineffective or impracticable for utilizing these materials in the formation of articles.

Although some known methods of releasing materials from molds include coating a steel mold with chrome-based coatings, applying mold release chemicals based on wax, silicone, or fluoropolymers, or using a release film, these methods do not provide any benefit to the function of the article being molded. In particular, employing such methods to fabricate articles out of macro-defect free cements as well as other high viscosity materials may facilitate the release of these adhesive materials, but would result in a formed article which has reduced strength and stiffness and is susceptible to surface defects, moisture absorption, and thus premature failure.

Other known methods include sandwich panel construction and hydroforming Sandwich panel construction typically involves manufacturing an article with top and bottom panels or skins with a high modulus and high strength material and including a low density and/or low cost core material in the center of the article. If metal panels are used in such construction, it is customary to preform or prefabricate such panels prior to filling the center cavity with the low density core material. Such core material may be a two-part polyurethane (designed to be solid or foamed) or other reactive polymer system. Yet another known method of preforming metal panels is hydroforming. If two panels are needed in a structure, double-blank hydroforming is a method that may be utilized. In such method, two panels are concurrently deformed to the shape of a mold cavity by the hydraulic pressure exerted by a working fluid, typically water-based although hydraulic oils can also be used. In the double-blank hydroforming method, the working fluid does not remain with the preformed metal panels as an integral component of the final article. If only one panel is needed, a method called rubber pad forming may be used. This process uses the high resistance of the rubber to flow as the force required to deform the sheet metal. Additionally, neither of the known sandwich panel construction nor double-blank hydroforming are suited for the utilization of macro-defect free cements or other high viscosity materials. In particular, neither method provides a high viscosity material as an integral component of the final article and which adheres to and forms the shape of outer layers against interior mold surfaces while being pressurized within a mold cavity to provide a unitary article, as sandwich panel construction is characterized by low density core material and double blank hydroforming requires low viscosity working fluids such as water-based fluids or hydraulic oils.

Thus, and unlike any known methods, the present disclosure can provide a system and method for manufacturing which effectively incorporates macro-defect free cements or other high viscosity materials in the formation of articles wherein the high viscosity material adheres to and forms the shape of outer layers against interior mold surfaces while being pressurized within a mold cavity such that the high viscosity material not only remains with the outer layers as an integral component of the final article, but also is adhesively bonded with, encapsulated within, and protected by the outer layers.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for manufacturing an article, the system comprising:
a first mold half and a second mold half, wherein the first mold half and the second mold half define a molding cavity therebetween;
wherein the molding cavity is configured to receive two outer layers and a high viscosity material provided between the two outer layers; and
an actuator configured to move at least one of the first mold half and the second mold half towards the other;
wherein the first mold half and the second mold half are configured to deform the high viscosity material in conformation with a shape of the article, and
wherein the high viscosity material fills a space between the two outer layers such that the two outer layers encase the high viscosity material therebetween.

2. The system of claim 1 further includes a heating module configured to at least partially cure the high viscosity material.

3. The system of claim 1, wherein the high viscosity material is a cementitious composite.

4. The system of claim 3, wherein the cementitious composite is macro-defect-free cement.

5. The system of claim 1, wherein the two outer layers are metal sheets.

6. A method of manufacturing an article, the method comprising:
providing a molding cavity between a first mold half and a second mold half;
receiving two outer layers containing a high viscosity material therebetween in the molding cavity;
moving at least one of the first mold half and the second mold half towards the other; and
deforming the high viscosity material by the first mold half and the second mold half in conformation with a shape of the article, wherein the high viscosity material deforms the two outer layers such that the two outer layers encase the high viscosity material therebetween.

7. The method of claim 6 further comprises at least partially curing the high viscosity material during deformation.

8. The method of claim 6 further comprises curing the article.

9. The method of claim 6 further comprises bonding the high viscosity material to the two outer layers by an adhesive.

10. The method of claim 6, wherein the high viscosity material is a cementitious composite.

11. The method of claim 10, wherein the cementitious composite is macro-defect-free cement.

12. The method of claim 6, wherein the two outer layers are metal sheets.

13. An article comprising:
a cementitious composite formed in a shape of the article; and
two metal sheets encasing the cementitious composite therebetween.

14. The article of claim 13, wherein the cementitious composite is bonded to the two metal sheets by an adhesive.

15. The article of claim 14, wherein the adhesive is heat activated.

16. The article of claim 13, wherein the cementitious composite is macro-defect-free cement.

17. The article of claim 13, wherein the two metal sheets have a thickness between 0.1 mm and 1 mm.

18. The article of claim 13, wherein the two metal sheets have a thickness between 0.1 mm and 0.5 mm.

19. The article of claim 13, wherein the two metal sheets are made of a ferrous material.

20. The article of claim 13, wherein the two metal sheets are made of stainless steel.
